(19) United States
(12) Patent Application Publication
(10) Pub. No.: US 2026/0319697 A1
(43) Pub. Date: Oct. 15, 2026

(54) ENHANCED MULTI-WORDLINE RAIN IN A MEMORY SUB-SYSTEM

(71) Applicant: Micron Technology, Inc., Boise, ID (US)

(72) Inventors: Lei Zhang, Singapore (SG); Cory Michael Steinmetz, Boise, ID (US); Michael G. Miller, Boise, ID (US)

(21) Appl. No.: 19/179,226

(22) Filed: Apr. 15, 2025

(51) Int. Cl. G06F 3/06

(52) U.S. Cl. CPC G06F 3/0656; G06F 3/0604; G06F 3/0679

(57) ABSTRACT

A system includes a buffer, a memory device, and one or more processing devices operatively coupled to the memory device and the buffer. The one or more processing devices to perform operations including writing a first plurality of page stripes of first data to the memory device, determining first redundancy metadata for the first plurality of page stripes, storing the first redundancy metadata in the buffer, and responsive to a size of the first redundancy metadata satisfying a threshold criterion: (i) determining parity data for the first redundancy metadata, (ii) generating a recovery page stripe from the first redundancy metadata and the parity data, and (iii) writing the recovery page stripe to the memory device.

### TECHNICAL FIELD

Embodiments of the disclosure relate generally to memory sub-systems, and, more specifically, relate to implementing enhanced multi-wordline RAIN in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2A is an example block diagram of a logical representation of various memory planes that are accessible by multiple memory interface channels, according to some aspects of the disclosure.

FIG. 2B illustrates how data written to a memory device maps to redundancy metadata written to the memory device, according to some aspects of the disclosure.

FIG. 3 is an example block diagram of a logical representation of two memory blocks, according to some aspects of the disclosure.

FIG. 4 is an example block diagram of a logical representation multiple memory page stripes according to some aspects of the disclosure.

FIG. 5 is a flow diagram of an example method to implement enhanced multi-wordline RAIN in a memory sub-system, according to some aspects of the disclosure.

FIG. 6 is a flow diagram of an example method to implement enhanced multi-wordline RAIN in a memory sub-system, according to some aspects of the disclosure.

FIG. 7 is a block diagram of an example computer system in which embodiments of the present disclosure may operate.

### DETAILED DESCRIPTION

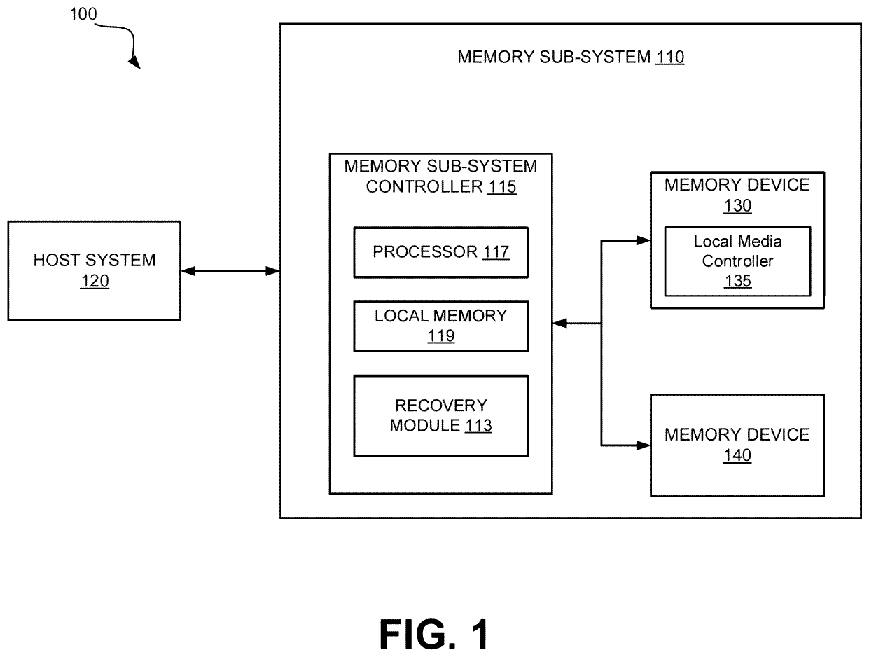

Aspects of the present disclosure are directed to implementing enhanced multi-wordline RAIN in a memory sub-system. A memory sub-system can be a storage device, a memory module, or a combination of a storage device and a memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high-density non-volatile memory devices where retention of data is desired when no power is supplied to the memory device. One example of a non-volatile memory device is a negative-AND (NAND) memory device. Other examples of non-volatile memory devices are described below in conjunction with FIG. 1. A non-volatile memory device is a package of one or more dies. Each die includes one or more planes. For some types of non-volatile memory devices (e.g., NAND devices), each plane includes a set of physical blocks. Each block consists of a set of pages. Each page includes a set of memory cells. A memory cell is an electronic circuit that stores information. Depending on the memory cell type, a memory cell can store one or more bits of binary information and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns and rows. A memory cell includes a capacitor that holds an electric charge and a transistor that acts as a switch controlling access to the capacitor. Accordingly, the memory cell can be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes).

Accordingly, one request to read a segment of data (e.g., corresponding to one or more data addresses), can result in read operations performed on two or more of the memory planes of the memory device.

Some memory devices can be three-dimensional (3D) memory devices (e.g., 3D NAND devices). For example, a 3D memory device can include memory cells that are placed between sets of layers including a pillar (e.g., polysilicon pillar), a tunnel oxide layer, a charge trap (CT) layer, and a dielectric (e.g., oxide) layer. For example, a 3D memory device can be a 3D replacement gate memory device having a replacement gate structure using wordline stacking.

The memory sub-system can perform host-initiated memory access operations. For example, the host system can initiate a data operation (e.g., write, read, erase, etc.) on a memory sub-system. The host system can send access requests (e.g., write command or read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g. used to distinguish age of data written), valid bitmap (which LBAs or logical transfer units contain valid data), etc.

A memory cell (“cell”) can be programmed (e.g., written to) by applying a certain voltage to the cell, which results in an electric charge being held by the cell. For example, a voltage signal V_{CG} can be applied to a control electrode of the cell to open the cell to the flow of electric current across the cell between a source electrode and a drain electrode. More specifically, for each individual cell (having a charge Q stored thereon), there can be a threshold control gate voltage V_{T} (also referred to as the “threshold voltage”) such that the source-drain electric current is low for the control gate voltage (V_{CG}) being below the threshold voltage, V_{CG}<V_{T}. The current increases substantially once the control gate voltage has exceeded the threshold voltage, V_{CG}>V_{T}. Because the actual geometry of the electrodes and gates varies from cell to cell, the threshold voltages can be different even for cells implemented on the same die. The cells can, therefore, be characterized by a distribution P of the threshold voltages, P(Q, V_{T})=dW/dV_{T}, where dW represents the probability that any given cell has its threshold voltage within the interval [V_{T}, V_{T}+dV_{T}] when charge Q is placed on the cell.

A memory device can exhibit threshold voltage distributions P(Q, V_{T}) that are narrow compared with the working range of control voltages tolerated by the cells of the device. Accordingly, multiple non-overlapping distributions P(Qₖ, V_{T}) (“valleys”) can be fit into the working range, allowing for storage and reliable detection of multiple values of the charge Qₖ, k=1, 2, 3 . . . . The distributions (valleys) are interspersed with voltage intervals (“valley margins”) where none (or very few) of the cells of the device have their threshold voltages. Such valley margins can, therefore, be used to separate various charge states Qₖ. The logical state of the cell can be determined by detecting, during a read operation, between which two valley margins the respective threshold voltage V_{T} of the cell resides. Specifically, the read operation can be performed by comparing the measured threshold voltage V_{T} exhibited by the memory cell to one or more reference voltage levels corresponding to known valley margins (e.g., centers of the margins) of the memory device.

One type of cell is a single level cell (SLC), which stores 1 bit per cell and defines 2 logical states (“states”) (“1” or “L0” and “0” or “L1”), each corresponding to a respective V_{T} level. For example, the “1” state can be an erased state (L0), and the “0” state can be a programmed state (L1). Another type of cell is a multi-level cell (MLC), which stores 2 bits per cell and defines 4 states (“11” or “L0”, “10” or “L1”, “01” or “L2” and “00” or “L 3”), each corresponding to a respective V_{T} level. For example, the “11” state can be an erased state, and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”), each corresponding to a respective V_{T} level. For example, the “111” state can be an erased state, and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. A memory device can include one or more arrays of memory cells such as SLCs, MLCs, TLCs, QLCs, PLCs, etc., or any combination of such. For example, a memory device can include an SLC portion, an MLC portion, a TLC portion, a QLC portion, or a PLC portion of cells.

A valley margin can also be referred to as a read window. For example, in an SLC cell, there is 1 read window that exists with respect to the 2 V_{T} distributions. As another example, in an MLC cell, there are 3 read windows that exist with respect to the 4 V_{T} distributions. As yet another example, in a TLC cell, there are 7 read windows that exist with respect to the 8 V_{T} distributions. Read window size generally decreases as the number of states increases. For example, the 1 read window for the SLC cell may be larger than each of the 3 read windows for the MLC cell, and each of the 3 read windows for the MLC cell may be larger than each of the 7 read windows for the TLC cell, etc. Read window budget (RWB) refers to the cumulative value of the read windows.

As data is repeatedly written and erased in a memory device, such as a flash memory, the memory device may be more susceptible to errors due to various types of noise and disturb mechanisms inherent within the memory cell, which may be exacerbated with repeated programming. As a result, the raw bit error rates (RBERs) for the memory device can increase over time. Given this pattern, the end-of-life RBERs for these devices are much higher as compared to the beginning-of-life RBERs for the respective devices.

To address read errors, a memory sub-system can use various error handling techniques to correct errors and verify that the data read from the memory device is the same as the data that was previously written to the respective memory device. In some embodiments, the error handling techniques can include performing one or more read retries using different parameters, such as a change in the threshold voltage offset as compared to the initial threshold voltage offset applied in performing a read operation on a set of memory cells.

Some error handling techniques can use redundancy metadata to correct errors in data written to the memory device. As used herein, “redundancy metadata,” refers to metadata that is generated from host data and allows the host data to be reconstructed in the event that the host data becomes corrupted. For example, redundancy metadata can include parity data, which may be calculated from the host data using mathematical operations such as an exclusive OR (XOR) operation. In another example, redundancy metadata can be generated and used in a redundant array of independent NAND (RAIN) to improve the reliability of a storage system. In a RAIN configuration, data such as host data is to be saved. A storage system can generate redundancy metadata for the host data and then write a portion of the host data along with the generated redundancy metadata to multiple memory devices. For example, if the storage system has four memory devices, the storage system can generate redundancy metadata from the host data, separate the host data into four portions, and then write each portion to one of the four memory devices along with the generated redundancy metadata. Notably, the redundancy metadata can be generated for the data before it is separated into smaller portions that are written to memory devices, and thus the redundancy metadata represents a full set of host data that was provided by the host system, and not just the portion of the set of host data written to a particular memory device. In some systems, the redundancy metadata can be generated for the data that is written to a particular memory device.

The redundancy metadata can be stored alongside the host data in the memory device. This, however, can impede the performance and long-term reliability of the memory device. When the redundancy metadata is stored alongside the host data, performing repeated memory operations on the memory device to read the redundancy metadata can cause excessive physical wear on the memory cells that contain host data. This is due in part to the minimal read threshold size for performing a read operation. That is, each time a read operation is performed, a minimum number of memory cells are accessed by the memory sub-system. When the redundancy metadata is smaller than the memory size of the minimum number of memory cells for a read operation, the content of the adjacent cells is still read and discarded.

Additionally, memory sub-systems can include multiple memory interface channel interfaces to perform memory access operations in parallel. For example, two memory interface channels can each access different memory locations simultaneously. However, when all of the redundancy metadata that is stored on the memory device is only accessible by the same memory interface channel, memory access operations for the redundancy metadata cannot be performed in parallel, thus slowing down the read, write, and/or modification operations performed on the redundancy metadata. For example, when reading a large quantity of redundancy metadata (such as during a RAIN operation to recover data that was stored on a now-failed memory device), the memory device may be limited to the access speed of the memory interface channel that has access the redundancy metadata, as the remaining memory interface channels are idle. Additionally, when performing memory operations to read data (e.g., host data) from the memory device, the redundancy metadata is necessarily read and subsequently discarded as part of the memory operation. This lowers the efficiency and performance of the memory device when performing read operations, especially when performing read operations for a RAIN recovery operation.

Aspects of the present disclosure address the above and other deficiencies by writing redundancy metadata as a full page stripe (e.g., a recovery page stripe). Parity data can be generated for the redundancy metadata in a similar way that redundancy metadata is generated for host data. For example, the parity data can be appended to the end of the redundancy metadata (e.g., as the last page written of the recovery page stripe). The parity data can provide significant additional redundancy data at a minimal storage cost by allowing for verification of the redundancy metadata.

When performing a write operation to write data to a memory device (e.g., host data), the memory sub-system can compute redundancy metadata for the data written by the write operation. As additional data (e.g., subsequent sets of host data) are written to the memory device, the memory sub-system can compute and maintain temporary redundancy metadata for each subsequent set of host data in a set of temporary redundancy metadata. For example, each time new data is written by a write operation, new redundancy metadata is computed, and the newly computed redundancy metadata is added to a temporary set of redundancy metadata (e.g., in a buffer). Once the size of the temporary redundancy metadata satisfies a predefined write threshold, the memory sub-system can write the temporary redundancy metadata to the memory device. The predefined write threshold can be selected based on the size of data that can be written by a memory access operation.

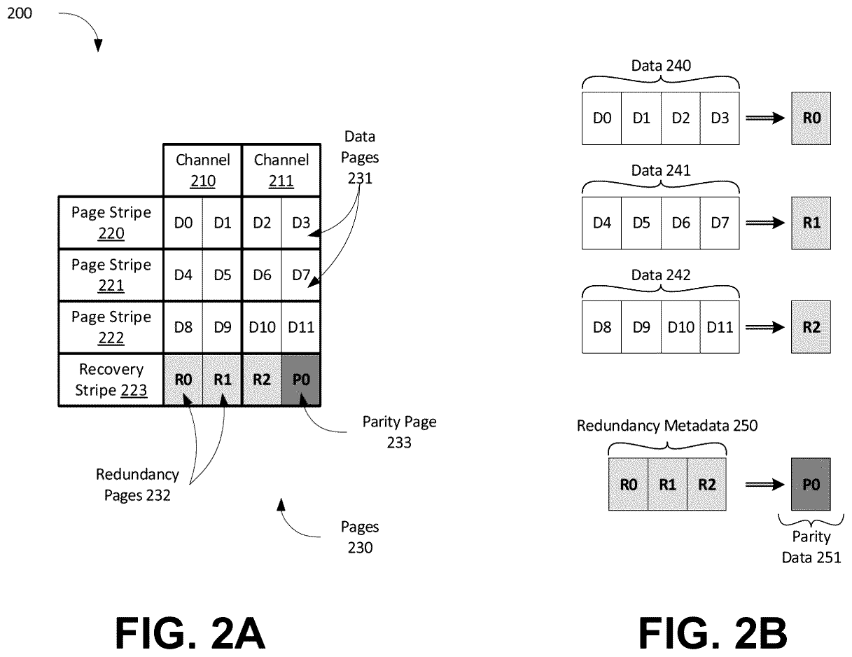

When the memory device performs a memory operation, a certain quantity of data is written, read, or modified as a memory unit (e.g., a page, page stripe, or predefined group of pages, such as a number of pages accessible by a memory channel). Once the memory unit has been processed by the memory operation (e.g., written, read, or modified) another memory unit (e.g., certain quantity of data) is processed by the memory operation. Thus, when the predefined write threshold is based on the certain quantity of data that is processed as a unity by a memory operation, when reading from memory, memory units that only contain redundancy metadata (e.g., recovery page stripes) can be skipped over. This allows the memory sub-system to perform a memory access operation for a recovery operation on memory units (e.g., recovery page stripes) that are full of recovery data (e.g., redundancy metadata and parity data for the redundancy metadata), and do not contain host data. This can result in a faster performance of recovery operations for the memory sub-system. Additional details regarding determining and writing the redundancy metadata are described below, particularly with reference to FIGS. 2A-4.

Advantages of the present disclosure include improved memory device performance and reliability. For example, embodiments described herein can achieve improved performance by accessing redundancy metadata using multiple memory interface channels as opposed to relying on a single channel to access redundancy metadata. Additionally, when the redundancy metadata is stored in chunks that correspond to the amount of data accessible by a single memory access operation, during read operations because those “chunks” only contain redundancy metadata, the chunks can be skipped over, providing additional read performance improvements when reading host data. Accordingly, embodiments described herein can be implemented to reduce read operation durations, reduce read operation throttling when reading redundancy metadata (e.g., during a RAIN recover operation), and increase the life and performance of a memory device.

The method described herein can be implemented with any suitable memory device architecture in accordance with the embodiments described herein. In one embodiment, the method can be implemented with a memory device implementing replacement gate NAND (RG NAND) technology. A replacement gate (RG) NAND device is a NAND device that implements a RG architecture rather than a floating gate (FG) architecture. The RG NAND architecture removes cell gaps that are typically found in FG NAND architectures, thereby reducing or eliminating capacitance resulting from those cell gaps. More specifically, the RG NAND architecture corresponds to a single-insulator structure. The RG NAND architecture can enable smaller size, improved read and write latency, and an increase in transfer rate as compared to the FG NAND architecture.

As used herein, “memory unit” can refer to a physical memory location, such as a memory cell (e.g., an SLC, TLC, QLC memory cell, etc.), or other distinct physical memory structure. Multiple physically adjacent pages can be grouped together to form a page stripe.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., non-volatile dual in-line memory module (NVDIMM) controller), and a storage protocol controller (e.g., peripheral component interconnect express (PCIe) controller, serial advanced technology attachment (SATA) controller, compute express link (CXL) controller, etc.). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a SATA interface, a CXL interface, a PCIe interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random access memory (SDRAM).

Some examples of non-volatile memory devices (e.g., memory device 130) include a not-AND (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single-level memory cells (SLC), can store one bit per memory cell. Other types of memory cells, such as multi-level memory cells (MLCs), triple-level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application-specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control the operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system controller 115 can implement a recovery module 113. The recovery module 113 can determine redundancy metadata for host data to be written to the memory device 130 of the memory sub-system 110. In some embodiments, the recovery module 113 receives redundancy metadata with the host data that is to be written. For example, the host data to be written may be a portion of a larger host data that has been separated into smaller portions, and the redundancy metadata can be redundancy metadata that was generated for the larger host data before the host data was split into the smaller portions. In alternative embodiments, the recovery module 113 can generate redundancy metadata for the host data to be written. For example, the host data can be received by the memory sub-system 110, and the recovery module 113 can generate redundancy metadata for the host data.

The recovery module 113 can track the amount of redundancy metadata that has been received or generated (e.g., determined) for each host data that is written to the memory device 130. In some embodiments, as the memory sub-system 110 writes data to the memory device 130, corresponding redundancy metadata is written to a memory cache, such as a short-term or volatile memory (not illustrated). In some embodiments, the memory cache is included in the recovery module 113. In alternative embodiments, the recovery module 113 can access a memory cache, such as a portion of the memory device 140 that is dedicated to storing redundancy metadata for the recovery module 113. In another embodiment, the memory cache is part of a memory cache pool in a volatile memory device that is not dedicated for any particular usage, but is allocated and used by components of the memory sub-system 110 as needed.

As the memory sub-system 110 writes data to the memory device 130 and generates corresponding redundancy metadata (e.g., to a redundancy memory cache), the recovery module 113 can determine whether a quantity of generated redundancy metadata satisfies a predetermined threshold (e.g., a write threshold). In some embodiments, the predetermined threshold is based on a number of memory locations (e.g., pages) in a read operation performed for all channels of a memory sub-system (e.g., a page stripe). That is, in some embodiments, the value of the predetermined threshold can be the same as the number of memory locations that are accessible by a single memory interface channel for a single memory operation for all memory channels. Once the recovery module 113 determines that a quantity of redundancy metadata in the buffer 460 satisfies the predetermined threshold, the recovery module 113 can determine parity data for the redundancy metadata. The recovery module 113 can use the recovery metadata and the parity data to generate a recovery page stripe. The recovery module 113 can cause the memory sub-system to write the recovery page stripe to the memory device. In some embodiments, the entirety of the buffer 460 is written to the memory device. In such embodiments, the predetermined threshold can be set based on the size of the buffer 460 and when the buffer 460 is full, the write threshold is satisfied. In some embodiments, the predetermined threshold can be determined based on a NAND defectivity type (e.g., bad block, program/read disturb errors, retention errors, program/erase (P/E) cycle errors, temperature errors, etc.), a defectivity coverage, a performance overhead, and an availability of system resources.

In some embodiments, the redundancy metadata can be generated using exclusive-OR (XOR) function or a Reed-Solomon coding. For an XOR-based function, a bitwise XOR function is performed across the relevant host data to generate the redundancy metadata. In similar fashion, when the parity data is generated for the redundancy metadata, a bitwise XOR function is performed across the relevant redundancy metadata to generate the parity data. For a Reed-Solomon coding, the equation P(x)=D(x)·G(x) may be used, where: D(x) is a polynomial representation of representative data symbols, G(x) is a generator polynomial, which defines the redundancy structure, and P(x) is a final codeword polynomial that includes both data and parity symbols. Generating redundancy metadata and/or parity data using Reed-Solomon coding can improve the quality of the generated recovery data, at the expense of compute resources and storage space. Additional algorithms and/or processes may be used to generate the redundancy metadata and/or parity data, and the above is meant only to provide two exemplary means for generating the redundancy metadata and/or parity data.

FIG. 2A is an example block diagram 200 of a logical representation of various memory planes that are accessible by multiple memory interface channels, according to some aspects of the disclosure. FIG. 2B is described together with FIG. 2A, and illustrates how data 240, data 241, and data 242 written to page stripe 220, page stripe 221, and page stripe 222 respectively, map to redundancy metadata 250.

The example block diagram 200 of FIG. 2A illustrates pages 230 of page stripe 220 through page stripe 222 that are each respectively accessible by channel 210 or channel 211. Each page 230 of a respective page stripe (e.g., page stripe 220, page stripe 221, etc.) can be grouped based on which memory interface channel is configured to access the page 230. For example, the pages D8 and D9 of page stripe 222 are accessible by channel 210, while the pages D10 and D11 are accessible by the channel 211. In some embodiments, the channel 210 and the channel 211 can each include two planes. Illustratively in FIG. 2A, channel 210 includes a first plane (D0, D4, D8, R0) and a second plane (D1, D5, D9, R1) and channel 211 includes a first plane (D2, D6, D10, R2) and a second plane (D3, D7, D11, P0).

The pages 230 include data pages 231, redundancy pages 232, and parity pages 233. Data is written to the data pages 231, and redundancy metadata for the written data is written to the redundancy pages 232. As used herein, a “redundancy page” describes a unit of recovery data (e.g., a page) that is generated to recover a page-stripe of data (e.g., page stripe 220). In some embodiments, the redundancy page is generated by performing an exclusive-OR (XOR) operation on a page-stripe of data (e.g., the page stripe 220). As used herein, a “parity page” describes a unity of recovery data (e.g., a page) that is generated to recover a group of redundancy pages (e.g., a page-stripe or similar quantity of redundancy pages). In some embodiments, the parity page can be similarly generated by performing an XOR operation on a group of redundancy pages. In some embodiments, the parity page 233 allows the values of the recovery pages to be recovered in the event of a failure at a memory location where the recovery page data is stored. In some embodiments, the parity page 233 allows for page stripes having more than one error to be recovered using the recovery data. For example, if there are two or more errors in the same page stripe (e.g., page stripe 220), then the redundancy metadata for that page stripe (e.g., redundancy page R0) is unable to recover the page stripe 220. However, by using the parity page 233, which stores a representation of the value of the redundancy page R0, in conjunction with the redundancy page R0, a page stripe having two errors may be recovered.

In some embodiments, data is written to the memory device in groups of pages that are accessible by a single memory interface channel during a memory operation (e.g., as a page stripe). For example, and as illustrated in FIG. 2B, data 240 is written to the pages D0 through D3 (e.g., the page(s) of page stripe 220 accessible by channel 210 and the channel 211). The data 240 maps to the redundancy metadata written to the redundancy page R0. That is, the redundancy metadata that is generated for the data 240 is stored at the redundancy page R0. Similarly, the data 241 maps to the redundancy metadata written to the redundancy page R1, and the data 242 maps to the redundancy metadata written to the redundancy page R2. Similarly, redundancy metadata 250 written to the pages R0 through R2 maps to the parity data 251 written to the parity page P0. That is, the parity data 251 that is generated for the redundancy metadata 250 is stored at the parity page P0.

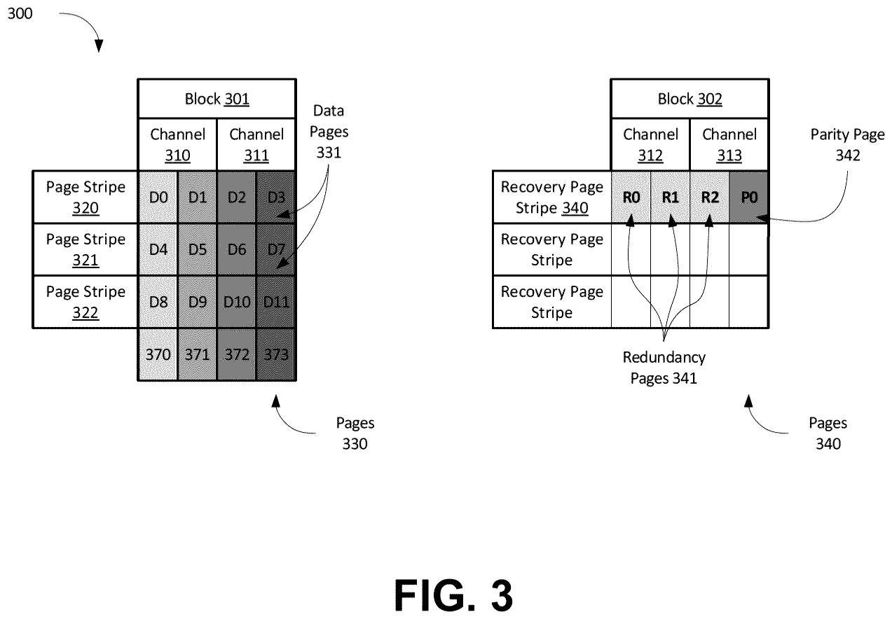

Returning to FIG. 2A, as illustrated, the predetermined threshold (e.g., the “write threshold”) for the set of redundancy metadata is three. That is, once a size of the redundancy metadata for host data (e.g., data 240, data 241, and data 242) is equal to or greater than three (e.g., three pages of redundancy metadata, where each page corresponds to a respective host data), parity data 251 is generated for the redundancy metadata 250. The redundancy metadata 250 and the parity data 251 are used to generate a recovery page stripe, which is written as the recovery stripe 223. It can be appreciated that the predetermined threshold can be greater than three, which is used here only illustratively. Additional details regarding the size of the predetermined threshold are described below with reference to FIGS. 3A-3B.

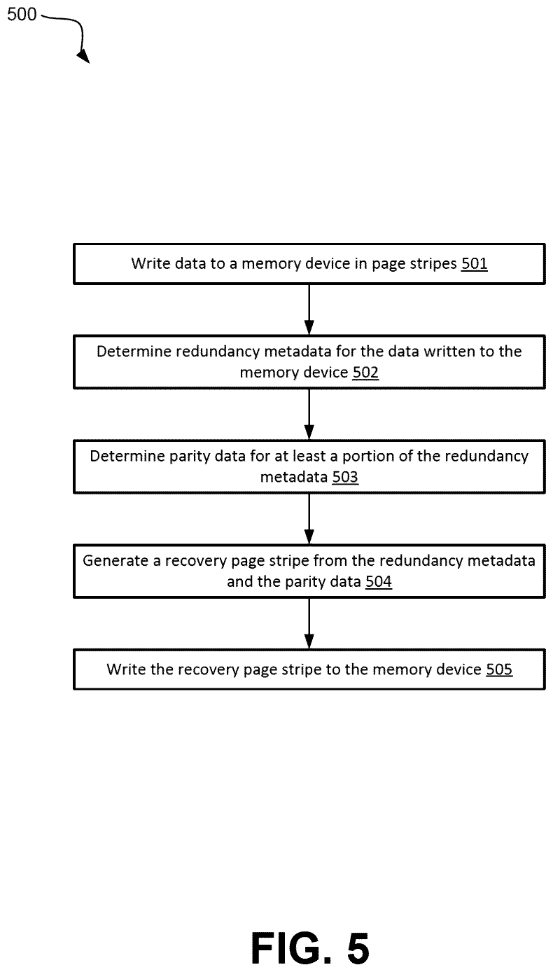

In some embodiments, the redundancy metadata 250 can be stored temporarily, such as in a memory cache, or by the recovery module 113 of FIG. 1. Additional details regarding the memory cache are described below with reference to FIG. 5. Once the quantity of redundancy metadata (e.g., the number of generated redundancy metadata) satisfies the predetermined threshold, the redundancy metadata is written from the temporary location to the memory device (e.g., in redundancy pages 232, respectively).

In some embodiments, the size of the data 240, the data 241, or the data 242 is of a predetermined size that fills a page stripe. Consequently, when enough redundancy metadata 250 has been generated to fill a page stripe minus one page for the parity data 251, then the parity data 251 is generated. In some embodiments, the parity data 251 can be larger than a single page. In such embodiments, the recovery page stripe includes less redundancy metadata 250, as the critical factor is that only redundancy metadata 250 and parity data 251 are written to the recovery stripe 223. This allows only host data (e.g., data pages 231) to be written to other page stripes of the memory device (e.g., page stripe 220, page stripe 221, page stripe 222, etc.). Thus, when read operations are performed on the memory device, the page stripes with host data (e.g., data pages 231) can be read (e.g., page stripe 220, page stripe 221, page stripe 222, etc.) while the page stripes with recovery data (e.g., the redundancy pages 232, parity pages 233, etc.) can be skipped (e.g., recovery stripe 223). That is, a memory controller can refrain from reading the recovery page stripe. This results in improved read operation durations, as the read operation does not read recovery data that otherwise may have been written in amongst the user data (e.g., data 240, data 241, data 242, etc.)

FIG. 3 is an example logical diagram 300 of a logical representation of two memory blocks, according to some aspects of the disclosure. FIG. 3 includes similar features and components that are described with reference to FIG. 2A and FIG. 2B. Thus, the same descriptions for FIG. 2A and FIG. 2B can similarly apply to FIG. 3 as applicable. For example, the channel 310 can be the same as or similar to the channel 210, and the page stripe 320, page stripe 321, and page stripe 322 can be the same as or similar to the page stripe 220, page stripe 221, and page stripe 222, respectively. The diagram 300 illustrates that the channel 310 can write to plane 370 and plane 371, and the channel 311 can write to plane 372 and plane 373 (as illustrated by vertical grey-scale).

In some embodiments, the recovery module 113 of FIG. 1 can write data (e.g., host data) to pages 330 of a first block, such as block 301, and write redundancy metadata generated for the written data to pages 340 of a second block, such as block 302. In contrast to the embodiments described with reference to FIG. 2A and FIG. 2B, in the embodiments illustrated in FIG. 3, the data pages 331 are contained in the block 301 while the redundancy pages 341 and parity pages 342 are contained in the block 302. In some embodiments, this can require the memory sub-system (e.g., memory sub-system 110 of FIG. 1) to simultaneously maintain two open blocks for write operations. In some embodiments, the recovery module 113 can allow both block 301 and block 302 to be simultaneously accessible for write operations when data is being written to the memory device 130. In some embodiments, multiple blocks worth of data can be written to fill the block 302 with corresponding redundancy metadata and parity data for the redundancy metadata. In some embodiments, the blocks with data (such as data 240) and the blocks with redundancy metadata can be located on the same physical die.

In some embodiments, once a page stripe of the block 302 (e.g., the page stripe 340) satisfies a threshold condition, parity data can be generated from the redundancy metadata written to the page stripe. In some embodiments, the threshold condition is based on (i) a number of pages that will be generated for the parity data and (ii) a number of pages of a page stripe to which redundancy metadata is written. Parity data is generated for redundancy metadata such that a sum of the number of pages that store the redundancy metadata (e.g., the redundancy pages 341) and the number of pages that store the parity data for the respective redundancy metadata (e.g., the parity page 342) are equal to the number of pages in a page stripe. As illustrated, a page stripe includes four pages. The recovery page stripe 340 includes three redundancy pages 341 and one parity page 342. In another example, a page stripe may include sixteen pages, with fifteen redundancy pages 341 and one parity page 342, or fourteen redundancy pages 341 and two parity pages 342. In another example a page stripe mag include thirty-two pages, with thirty-one redundancy pages 341 and one parity page 342, or any other combination of redundancy pages 341 and parity pages 342 that sum to thirty-two (e.g., the total number of pages in the page stripe, such as recovery page stripe 340).

When read operations are performed by the memory sub-system on the block 301, there is no unnecessary redundancy metadata to read and process. Data is accessed from the block 301, such as from the data pages D0 and D1 on the page stripe 320 via the channel 310, or from the data pages D2 and D3 on the page stripe 320 via the channel 311. Similarly, when read operations are performed on the redundancy metadata, only the page stripe that contains the redundancy metadata for damaged or corrupted data is read, as opposed to reading all page stripes in a plane (e.g., the plane 370, the plane 371, the plane 372, or the plane 373) or similar memory structure (as may occur when the redundancy metadata is stored in the same plane or page stripe as the host data used to generate the redundancy metadata). Additionally, this allows for more efficient use of the memory interface channels of the memory device. Since the redundancy metadata is stored in memory locations that are accessible by all memory interface channels (e.g., channel 312 and channel 313) of the memory device for the page stripes 320, 321, 322 of the the block 302, the memory operations to read the redundancy metadata are spread out across multiple channels.

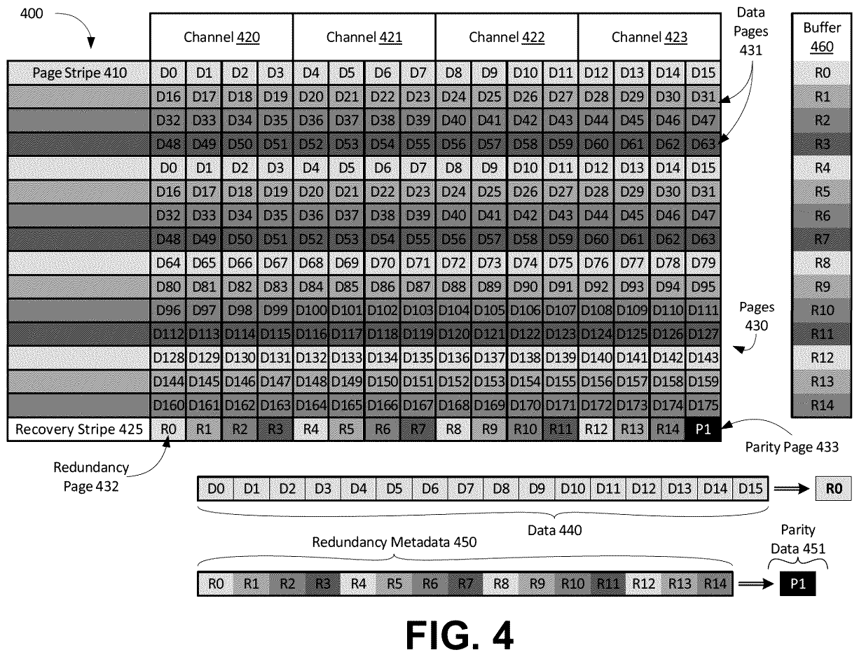

FIG. 4 is an example block diagram 400 of a logical representation of multiple memory page stripes, according to some aspects of the disclosure. FIG. 4 includes similar features and components as FIG. 2A and FIG. 2B, albeit with four planes accessible by each of four channels (e.g., four sets of four pages in each page stripe). Channel 420 can access four memory planes, channel 421 can access four memory plane, channel 422 can access four memory planes, and channel 423 can access four memory planes. As illustrated, the data 440 can correspond to the redundancy metadata item R0. That is, in the illustrative FIG. 4, sixteen data pages 431 correspond to one redundancy page 432. As similarly illustrated, the redundancy metadata 450 can correspond to the parity data item P1. That is, in the illustrative FIG. 4, fifteen redundancy pages 432 correspond to one parity page 433. Similarly, as illustrated, the write threshold in FIG. 4 can be fifteen, or the same quantity of pages 430 in a page stripe, minus one page for the parity data. In some embodiments, the buffer 460 can store fifteen redundancy metadata items. In some embodiments, the buffer 460 can further store one parity data item. Once the buffer 460 is full, the contents can be written as a recovery stripe 425. In some embodiments, the contents of the buffer 460 can be used to generate a recovery page stripe to be written to the recovery stripe 425. In some embodiments, when a size of the buffer 460 satisfies a threshold condition, a portion of the contents can be written to the recovery stripe 425.

FIG. 4 additionally includes a representative illustration of the buffer 460. When data 440 is written to the page stripe 410, the memory sub-system of FIG. 1, or a component of the memory sub-system such as the recovery module 113, can generate and write redundancy metadata to the buffer 460 at the first available location of the buffer 460 (“R0,” as illustrated). As subsequent data is written in page stripes to the memory device, additional redundancy metadata 450 can be generated and stored to available locations in the buffer 460. In FIG. 4, these additional data writes, and corresponding generated redundant metadata are indicated by sharing the same shade of gray.

As described above with reference to FIG. 1, the buffer 460 can be a separate memory device, such as a volatile or short-term memory device. In some embodiments, the buffer 460 is a part of a component such as the recovery module 113 of FIG. 1. In alternative embodiments, the buffer 460 is a portion of a shared or pooled memory cache for the memory sub-system 110 that is accessible by the recovery module 113.

In some embodiments, the write threshold can be based on the size of the buffer 460. That is, the write threshold may be triggered when the buffer 460 is full. In some embodiments, this is one way to control the pre-determined write threshold for the memory sub-system 110. In some embodiments, once the buffer 460 has been filled, the memory sub-system 110 can determine parity data 251 for the redundancy metadata 450. The memory sub-system 110 can generate a recovery page stripe from the redundancy metadata 250 and the parity data 451 and write the recovery page stripe to the memory device as the recovery stripe 425. In the illustrative FIG. 4, the buffer 460 is written in line with other page stripes storing host data (e.g., host data). In alternative embodiments, such as is illustrated with reference to FIG. 3, the buffer 460 can be written to another memory block memory die, or the like. After the memory sub-system has written the contents of the buffer 460 to the memory device (e.g., the memory device 130), the buffer 460 may be cleared. In alternative embodiments, new redundancy metadata may be written over the now-old redundancy metadata. In some embodiments, the size of the buffer 460 is larger than the write threshold. That is, when the write threshold is satisfied, only a portion of the buffer 460 is written to the memory device.

FIG. 5 is a flow diagram of an example method 500 to implement enhanced multi-wordline RAIN in a memory sub-system, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the recovery module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the processing logic performing the method 500 writes data to a memory device. In some embodiments, the data is host data. In some embodiments, the data is written as page stripes. In some embodiments, the data is written to the memory device in other pre-determined quantities. In some embodiments, the quantity of data written as a group is based on a minimum amount of data that is accessible by a read operation. In some embodiments, the quantity of data written as a group is based on an amount of data that is accessible by all memory channels during a read operation.

At operation 502, the processing logic determines redundancy metadata for the data written to the memory device. In some embodiments, the redundancy metadata is determined for each group of data that is written (e.g., for each page stripe). In the event of a memory read error, the redundancy metadata can be used to recover some or all of the host data that caused the memory read error. As described above with reference to FIG. 4, a redundancy metadata item (e.g., R0 as illustrated) can be determined for each page stripe of data 440 that is written to the memory device. In some embodiments, the redundancy metadata can be determined using, for example, an XOR bitwise function. The XOR bitwise function can be performed with all of the data items (e.g., data pages 431) of a page stripe (e.g., page stripe 410) to generate the redundancy metadata item (e.g., R0). The redundancy metadata can be temporarily stored in a buffer (e.g., the buffer 460) until a quantity of redundancy metadata items or size of the redundancy metadata satisfies a threshold criterion.

At operation 503, the processing logic determines parity data for at least a portion of the redundancy metadata. Parity data can represent recovery data for at least a portion of the redundancy metadata. In the event of a host data read error, the redundancy metadata can be used to help correct the host data read error. In the event of a redundancy metadata read error, the parity data can be used to help correct the redundancy metadata read error. The parity data can be determined with respect to the redundancy metadata similar to how the redundancy metadata is determined with respect to the host data. That is, in some embodiments, the parity data can be determined, using, for example, an XOR bitwise function. The XOR bitwise function can be performed with all of the redundancy metadata items (e.g., redundancy metadata 450) of a recovery page stripe (e.g., written to the recovery stripe 425) to generate the parity data item (e.g., parity data 451). The size of the portion of the redundancy metadata for which parity data is generated can be based on a size of groups of data that are written to the memory device (e.g., a page stripe). That is, the combined size of the portion of redundancy metadata and the parity data can be the same as the size of the group of data written to the memory device in the operation 501, above.

At operation 504, the processing logic generates a recovery page stripe from the redundancy metadata and the parity data. The processing logic can combine the portion of redundancy metadata that was used to generate the parity data with the parity data into a group of data items that has a size that is the same as a size of a page stripe. In some embodiments, the recovery page stripe has N-locations, where N-1 locations are full of redundancy metadata and the last location contains the parity data. In some embodiments, the parity data can occupy more than a single memory location. In some embodiments, the parity data can be temporarily written to the buffer 460 of FIG. 4 to generate the recovery page stripe. That is, the parity data can be appended to the redundancy metadata used to generate the parity data. As described with reference to the operation 504, the combined size of the redundancy metadata and the parity data can be the same as a size of the page stripe. In this way, the recovery page stripe that is generated fills an entire page stripe of the memory device for an efficient means of writing and reading the recovery metadata and parity data.

At operation 505, the processing logic writes the recovery page stripe to the memory device. In some embodiments, the recovery page stripe is written to a different location in the memory device from the data written in page stripes of the operation 501, such as is described above with reference to FIG. 3. That is, in some embodiments, the host data can be written to a first set of memory blocks (e.g., including the block 301) while the recovery data (e.g., as the recovery page stripe) is written to set of memory blocks (e.g., including the block 302). In alternative embodiments, the host data and recovery data are written sequentially to the same memory locations, such as is illustrated with reference to FIG. 4. Page stripes (e.g., including the page stripe 410) are written sequentially to the memory block until the buffer 460 is full, or until the threshold criterion for generating the recovery page stripe is satisfied. Once the threshold criterion is satisfied, the parity data is generated. The recovery data (e.g., recovery page stripe) is generated and written sequentially, following the host data (e.g., in the preceding page stripes) as the recovery stripe 425.

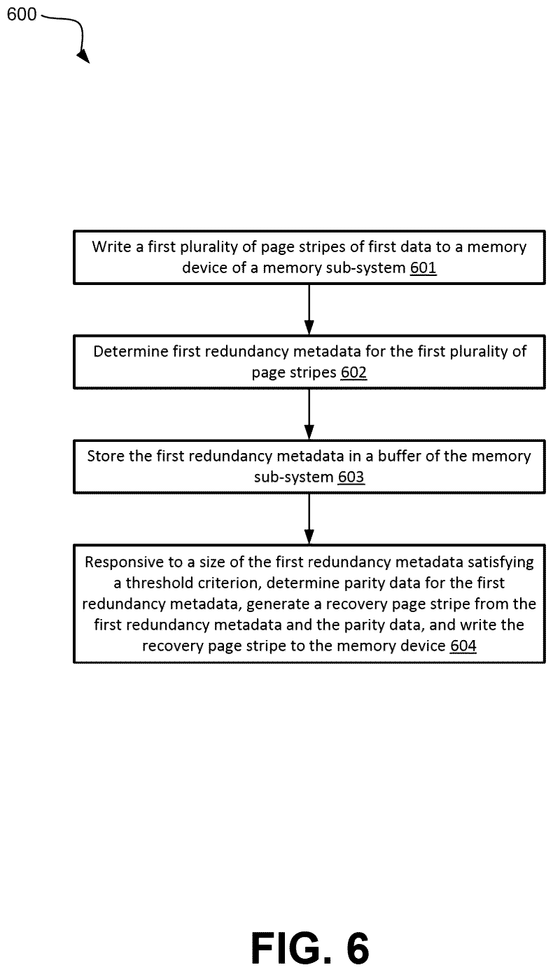

FIG. 6 is a flow diagram of an example method 600 to implement enhanced multi-wordline RAIN in a memory sub-system, according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the recovery module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the processing logic performing the method 600 writes a plurality of page stripes of first data to a memory device of a memory sub-system. In some embodiments, the first data is host data. In some embodiments, a quantity of the plurality of page stripes is based on a number of pages in a page stripe. For example, and with reference to FIG. 4, there are sixteen pages in a page stripe. This means that fifteen redundancy metadata items (e.g., the redundancy metadata 450) can be generated for fifteen respective page stripes, leaving one final page for the parity data item (e.g., the recovery data for the redundancy metadata). Thus, the number of the plurality of page stripes written before a recovery page stripe is generated and written can be fifteen.

At operation 602, the processing logic determines first redundancy metadata for the first plurality of page stripes. As described above, the redundancy metadata is data that can be used to correct one or more errors caused by corrupted host data during a read operation. In some embodiments, the redundancy metadata is generated using an XOR operation on the host data. In some embodiments, the first redundancy metadata is generated by page stripe. That is, as each page stripe is written, the processing logic can determine a respective redundancy metadata item for the page stripe, and store the respective redundancy metadata item (e.g., in the buffer 460). In alternative embodiments, the first redundancy metadata can be generated in bulk. That is, multiple page stripes can be written to the memory device, and after a certain quantity of page stripes have been written, redundancy metadata can be generated for the quantity or written page stripes. In some embodiments, the redundancy metadata can be generated in bulk as a part of generating the recovery data stripe. That is, the processing logic can write the plurality of page stripes to the memory device, and once a threshold criterion is satisfied, the processing logic can generate redundancy metadata for the plurality of page stripes all at once.

At operation 603, the processing logic stores the first redundancy metadata in a buffer of the memory sub-system. In some embodiments, the buffer (e.g., buffer 460 of FIG. 4) has a predetermined size. Once the buffer 460 is full, the redundancy metadata can be used to generate parity data (e.g., recovery data for the redundancy metadata). In some embodiments, the buffer 460 can have additional memory locations to temporarily store the parity data that is generated for the redundancy metadata.

At operation 604, responsive to a size of the first redundancy metadata satisfying a threshold criterion, the processing logic (i) determines parity data for the first redundancy metadata, (ii) generates a recovery page stripe from the first redundancy metadata and the parity data, and (iii) writes the recovery page stripe to the memory device.

In some embodiments, the threshold criterion is based on a number of memory locations in a page stripe of the memory device. That is, in some embodiments, if the number of data items in the redundancy metadata is one less than the number of locations in a page stripe of the memory device, the threshold criterion is satisfied. In some embodiments, the number of data items in the redundancy metadata and a known number of data items of parity data to be generated for the redundancy metadata sum to a number of locations in the page stripe, as described herein above.

In some embodiments, the threshold criterion is based on a number of memory locations of the memory device that are accessed to perform a read operation. In some embodiments, a page stripe of the memory device is accessed to perform a read operation. That is, in some embodiments, if the number of data items in the redundancy metadata is one less than the number of locations accessed to perform a read operation on the memory device, the threshold criterion is satisfied. In some embodiments, the number of data items in the redundancy metadata and a known number of data items of parity data to be generated for the redundancy metadata sum to a number of locations in the page stripe, as described herein above. That is, the number of data items may me more than one less than the number of locations if a size of the generated parity data is greater than one data item (e.g., one page).

In some embodiments, the threshold criterion is based on a size and/or status of the buffer. In some embodiments, the buffer has a predetermined size. In some embodiments, when the buffer is full (e.g., as indicated by size or status of the buffer), the threshold criterion is satisfied. In some embodiments, responsive to writing the recovery page stripe to the memory device, the buffer can be prepared to store new redundancy metadata. In some embodiments, the old redundancy metadata is overwritten by the new redundancy metadata. In some embodiments, the values of memory locations in the buffer are reset to a default value. In some embodiments, a flag or status is set that indicates that the buffer now contains garbage data (e.g., junk data).

In some embodiments, responsive to receiving a request to read data including the first data from the memory device, the processing logic (i) reads the first plurality of page stripes, and (ii) refrains from reading the recovery page stripe. For example, the data may include first data, followed sequentially by the recovery page stripe, followed sequentially by second data. The processing logic can read the first data, refrain from reading the recovery page stripe (e.g., skip the recovery page stripe), and read the second data. In some embodiments, responsive to receiving a request to read recovery data including the recovery page stripe, the processing logic can refrain from (e.g., skip) reading the first data at a first group of page stripes, read the recovery page stripe, and then refrain from (e.g., skip) reading the second data at a second group of page stripes. In alternative embodiments, the recovery page stripe is written to another portion of the memory device (e.g., another block).

In some embodiments, the processing logic further writes a second plurality of page stripes to the memory device, determines second redundancy metadata for the second plurality of page stripes, and responsive to determining the second redundancy metadata, overwrites the first redundancy metadata stored in the buffer with the second redundancy metadata.

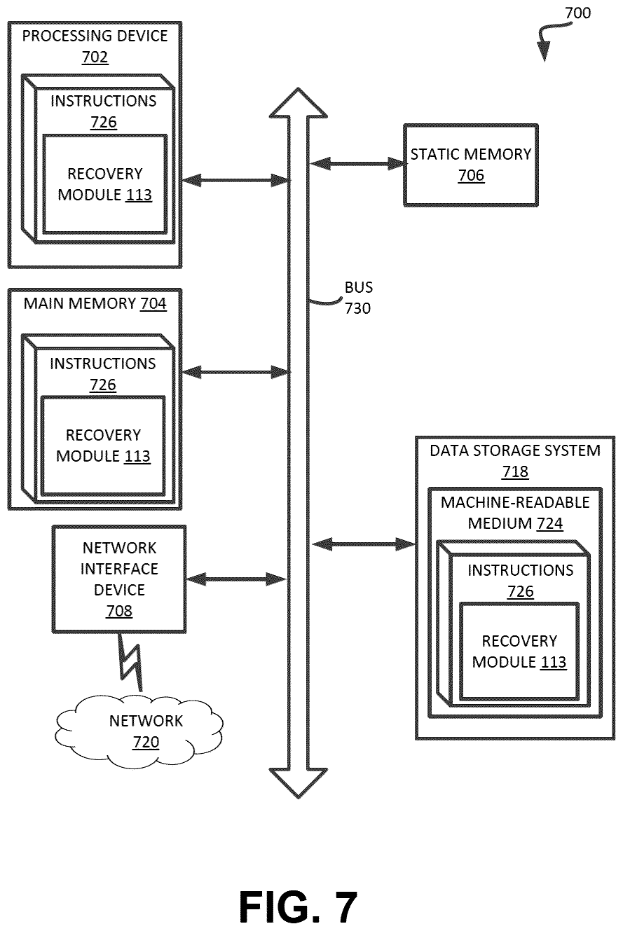

FIG. 7 illustrates an example of a computer system 700 within which a set of instructions, for causing the machine to perform any one or more of the methodologies discussed herein, can be executed, in accordance with aspects of the disclosure. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the recovery module 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable non-transitory storage medium) on which is stored one or more sets of instructions 726 or software embodying any one or more of the methodologies or functions described herein. In some embodiments, the data storage system 718 can include a computer-readable non-transitory storage medium, and can be operatively coupled to the processing device 702. The instructions 726 can also reside, completely or at least partially, within the main memory 704 and/or within the processing device 702 during execution thereof by the computer system 700, the main memory 704 and the processing device 702 also constituting machine-readable storage media. In some embodiments, the instructions 726 can be refer to executable instructions. The machine-readable storage medium 724, data storage system 718, and/or main memory 704 can correspond to the memory sub-system 110 of FIG. 1.

In some embodiments, the instructions 726 include instructions to implement functionality corresponding to the recovery module 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory.

These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated.

It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a buffer;
a memory device; and
one or more processing devices operatively coupled to the memory device and the buffer, the one or more processing devices to perform operations comprising:
writing first data to a first plurality of page stripes of a first block of the memory device;
determining first redundancy metadata for the first plurality of page stripes;
storing the first redundancy metadata in the buffer; and
responsive to a size of the first redundancy metadata satisfying a threshold criterion:
determining parity data for the first redundancy metadata;
generating a recovery page stripe from the first redundancy metadata and the parity data; and
writing the recovery page stripe to a second block of the memory device, wherein the first block and the second block are accessible concurrently for memory operations.

2. The memory sub-system of claim 1, wherein the one or more processing devices are to perform operations further comprising:
responsive to receiving a request to read data comprising the first data from the memory device:
reading the first plurality of page stripes; and
refraining from reading the recovery page stripe.

3. The memory sub-system of claim 1, wherein the threshold criterion is based on a number of memory locations in a page stripe of the memory device.

4. The memory sub-system of claim 1, wherein the threshold criterion is based on a number of memory locations of the memory device that are accessed to perform a read operation using memory interface channels of the memory device.

5. The memory sub-system of claim 1, wherein the one or more processing devices are to perform operations further comprising:
responsive to writing the recovery page stripe to the memory device, preparing the buffer to store new redundancy metadata.

6. The memory sub-system of claim 1, wherein the buffer has a predetermined size corresponding to a size of the recovery page stripe, wherein the threshold criterion is based on the predetermined size of the buffer.

7. The memory sub-system of claim 6, wherein the size of the first redundancy metadata satisfies the threshold criterion when the buffer is full.

8. The memory sub-system of claim 1, wherein the one or more processing devices are to perform operations further comprising:
writing a second plurality of page stripes of data to the memory device;
determining second redundancy metadata for the second plurality of page stripes; and
responsive to determining the second redundancy metadata, overwriting the first redundancy metadata stored in the buffer with the second redundancy metadata.

9. A method comprising:
writing first data to a first plurality of page stripes of a first block of a memory device;
determining first redundancy metadata for the first plurality of page stripes;
storing the first redundancy metadata in a buffer; and
responsive to a size of the first redundancy metadata satisfying a threshold criterion:
determining parity data for the first redundancy metadata;
generating a recovery page stripe from the first redundancy metadata and the parity data; and
writing the recovery page stripe to a second block of the memory device, wherein the first block and the second block are accessible concurrently for memory operations.

10. The method of claim 9, further comprising
responsive to receiving a request to read data comprising the first data from the memory device:
reading the first plurality of page stripes; and
refraining from reading the recovery page stripe.

11. The method of claim 9, wherein the threshold criterion is based on a number of memory locations in a page stripe of the memory device.

12. The method of claim 9, wherein the threshold criterion is based on a number of memory locations of the memory device that are accessed to perform a read operation using memory interface channels of the memory device.

13. The method of claim 9, further comprising:
responsive to writing the recovery page stripe to the memory device, preparing the buffer to store new redundancy metadata.

14. The method of claim 9, wherein the buffer has a predetermined size corresponding to a size of the recovery page stripe, wherein the threshold criterion is based on the predetermined size of the buffer.

15. The method of claim 14, wherein the size of the first redundancy metadata satisfies the threshold criterion when the buffer is full.

16. The method of claim 9, further comprising
writing a second plurality of page stripes of data to the memory device;
determining second redundancy metadata for the second plurality of page stripes; and
responsive to determining the second redundancy metadata, overwriting the first redundancy metadata stored in the buffer with the second redundancy metadata.

17. A computer-readable non-transitory storage medium comprising executable instructions that, when executed by a controller managing a memory sub-system, cause the controller to perform operations comprising:
writing first data to a first plurality of page stripes of a first block of a memory device of the memory sub-system;
determining first redundancy metadata for the first plurality of page stripes;
storing the first redundancy metadata in a buffer; and
responsive to a size of the first redundancy metadata satisfying a threshold criterion:
determining parity data for the first redundancy metadata;
generating a recovery page stripe from the first redundancy metadata and the parity data; and
writing the recovery page stripe to a second block of the memory device, wherein the first block and the second block are accessible concurrently for memory operations.

18. The computer-readable non-transitory storage medium of claim 17, wherein the instructions cause the controller to perform operations further comprising:
reading the first plurality of page stripes; and
refraining from reading the recovery page stripe.

19. The computer-readable non-transitory storage medium of claim 17, wherein the threshold criterion is based on a number of memory locations of the memory device that are accessed to perform a read operation using memory interface channels of the memory device.

20. The computer-readable non-transitory storage medium of claim 17, wherein the threshold criterion is based on a number of memory locations in a page stripe of the memory device.
